(19) United States
(12) Patent Application Publication
(10) Pub. No.: US 2025/0024472 A1
(43) Pub. Date: Jan. 16, 2025

(54) MULTI-HOP SIDELINK CONFIGURED GRANT SCHEDULING

(71) Applicant: Dell Products, L.P., Round Rock, TX (US)

(72) Inventor: Ali Esswie, Calgary (CA)

(21) Appl. No.: 18/352,167

(22) Filed: Jul. 13, 2023

(51) Int. Cl. H04W 72/40; H04W 72/542

(52) U.S. Cl. CPC H04W 72/40; H04W 72/542; H04W 88/04

(57) ABSTRACT

A source user equipment may determine a sidelink path, or sidelink route, comprising one or more relay user equipment to deliver traffic to a destination user equipment. The source user equipment may determine an end-to-end latency and may determine latency sub-budgets and corresponding timing information relative to the one or more relay user equipment, or one or more links associated therewith, and may transmit the determined timing information in a sidelink configured grant configuration request. The relay user equipment may use the determined timing information to determine frequency resources to use to relay traffic toward the destination user equipment such that the latency sub-budget(s) corresponding to the one or more relay user equipment is/are satisfied. A relay user equipment may determine the frequency resources based on channel conditions corresponding to a link between the relay user equipment and a user equipment along the sidelink path toward the destination user equipment.

### BACKGROUND

The ‘New Radio’ (NR) terminology that is associated with fifth generation mobile wireless communication systems (“5G”) refers to technical aspects used in wireless radio access networks (“RAN”) that comprise several quality of service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance and delivery of traffic, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary.

Sidelink communications may facilitate a variety of cellular use-cases such as autonomous vehicle crash avoidance, public avoidance, coordinated vehicle cruise control, and the like, where devices become able to communicate and coordinate directly with each other without communication messaging and signaling going through the RAN network. This is particularly important in cases where some of or all user equipment that coordinate as part of a sidelink group are located beyond RAN wireless coverage. In scenarios where user equipment are beyond RAN coverage, RAN nodes may control how sidelink resources are dynamically reserved and released for each device to prevent more than one user equipment of a sidelink group transmitting simultaneously on partially or fully overlapping sidelink resource to avoid transmission collision.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise determining, by a source user equipment comprising a processor, at least one first traffic parameter metric target corresponding to at least one protocol data unit associated with traffic directed to a destination user equipment via a relay user equipment, to result in at least one determined first traffic parameter metric target. The source user equipment, the relay user equipment, or the destination user equipment and links therebetween may compose a sidelink path, or sidelink route. The determined first traffic parameter metric may be determined based on a connection request transmitted by the destination user equipment. Based on the at least one determined first traffic parameter metric target, the method may further comprise determining, by the source user equipment, a sidelink configuration, which may be referred to herein as a sidelink configured grant configuration request, comprising at least one second traffic parameter metric target, corresponding to a relay communication link between the relay user equipment and the destination user equipment, usable by the relay user equipment to determine at least one relay resource, for example a frequency bandwidth, to use for transmission of the at least one protocol data unit to the destination user equipment via the relay communication link. The method may further comprise transmitting, by the source user equipment to the relay user equipment, the sidelink configuration, or sidelink configured grant configuration request.

In an embodiment, the at least one determined first traffic parameter metric target may be an end-to-end latency criterion corresponding to a latency associated with at least one protocol data unit being transmitted by the source user equipment and being received by the destination user equipment. Put another way, the end-to-end latency may be a latency budget/requirement/ to be applied to the at least one protocol data unit being delivered from the source user equipment to the destination user equipment via a side link path that may comprise the relay easier equipment.

In an embodiment, the at least one second traffic parameter metric target may comprise a time parameter metric target. The time parameter metric target may comprise a relay resource occasion indication indicative of a relay resource occasion, such as a period, to transmit, by the relay user equipment to the destination user equipment, the at least one protocol data unit. In an embodiment, the at least one relay resource may correspond to a frequency range usable by the relay user equipment to transmit the at least one protocol data unit during the relay resource occasion. In an embodiment, the relay resource occasion indication may be at least one of: a relay resource occasion start time indication indicative of a latest start time corresponding to the relay resource occasion, a relay resource occasion end time indication indicative of a latest end time corresponding to the relay resource occasion, or a relay resource occasion duration indication indicative of a maximum duration corresponding to the relay resource occasion.

In an embodiment, the relay resource occasion start time indication may be indicative of an offset from a transmitted time corresponding to the at least one protocol data unit being transmitted, by the source user equipment, to the destination user equipment. The relay resource occasion start time indication may be indicative of a latest start time that the relay user equipment can begin transmission to a next user equipment.

In an embodiment, the relay user equipment may be a first relay user equipment and the relay communication link may be a first relay communication link. The at least one relay resource may be at least one first relay resource, and the sidelink configuration may further comprise at least one third traffic parameter metric target, corresponding to a second relay communication link between a second relay user equipment and the destination user equipment, usable by the second relay user equipment to determine at least one second relay resource to use to transmit the traffic to the destination user equipment via the second relay communication link. The sidelink configuration may be transmitted by the first relay user equipment to the second relay user equipment. In an embodiment, the method may further comprise transmitting, by the source user equipment to the second relay user equipment, the sidelink configuration. The sidelink configuration, or sidelink configured grant configuration request, may be determined by the source user equipment based on the at least one determined first traffic parameter metric target.

In an embodiment, the relay user equipment may be a first relay user equipment and the source user equipment may be a second relay user equipment. The relay communication link may be a first relay communication link. The at least one relay resource may be at least one first relay resource. The transmission of the at least one protocol data unit may be a first transmission. The sidelink configuration may be a modified/updated/new sidelink configuration and may be based on channel conditions corresponding to at least the first relay communication link. The method may further comprise receiving, by the second relay user equipment from a third relay user equipment, a source sidelink configuration that comprises the at least one second traffic parameter metric target and at least one third traffic parameter metric target, corresponding to a second relay communication link between the third relay user equipment and the second relay user equipment, usable by the second relay user equipment to determine at least one second relay resource to use for a second transmission of the at least one protocol data unit to the destination user equipment via the second relay communication link. Based on the at least one determined first traffic parameter metric target, the method may further comprise determining, by the second relay user equipment, the at least one second relay resource to use for the second transmission of the at least one protocol data unit to the first relay user equipment via the second relay communication link. The method may further comprise transmitting, by the second relay user equipment to the first relay user equipment, the modified sidelink configuration for use by the first relay user equipment in determining the at least one first relay resource.

In an embodiment, the at least one first relay resource may be determined by the first relay user equipment based on a first channel condition metric corresponding to the first relay communication link, and the at least one second relay resource may be determined by the second relay user equipment based on a second channel condition metric corresponding to the second relay communication link.

In an embodiment, the at least one second traffic parameter metric target may comprise a minimum data rate corresponding to transmission of the at least one protocol data unit, by the relay user equipment to the destination user equipment, via the relay communication link.

In another example embodiment, a first user equipment may comprise a processor configured to receive, from a second user equipment, a sidelink configuration comprising a sidelink occasion indication indicative of a sidelink occasion corresponding to a traffic parameter metric target associated with a protocol data unit directed to a third user equipment and corresponding to a sidelink communication link between the first user equipment and the third user equipment. The processor may be further configured to determine a channel condition corresponding to the sidelink communication link to result in a determined sidelink channel condition. The processor may be further configured to determine, based on the determined sidelink channel condition, a sidelink relay resource to transmit the protocol data unit to the destination user equipment via the sidelink communication link according to the sidelink occasion to result in a determined sidelink relay resource. The processor may be configured to receive, from the second user equipment, the protocol data unit and the processor may be further configured to transmit, to the third user equipment via the sidelink communication link, the protocol data unit according to the determined sidelink relay resource and the sidelink occasion.

In an embodiment, the traffic parameter metric target may be an allowable sidelink latency associated with the protocol data unit being transmitted by the first user equipment and being received by the third user equipment, and the traffic parameter metric target may be, or may be based on, an end-to-end latency associated with the protocol data unit being transmitted by the second user equipment and being received by the third user equipment.

In an embodiment, the end-to-end latency may be determined by the second user equipment based on at least the sidelink communication link being a sidelink segment of a sidelink route, or path, from the second user equipment to the third user equipment. In an embodiment, the end-to-end latency may be determined by the second user equipment based on a type of traffic to be delivered from the second user equipment to the third user equipment, a quality-of-service associated with traffic to be delivered from the second user equipment to the third user equipment, or one or more device capabilities corresponding to one or more user equipment that make up a sidelink path/route.

In an embodiment, the sidelink configuration, or sidelink configured grant configuration request, may further comprises a traffic data rate corresponding to the protocol data unit, and determination of the sidelink relay resource may be further based on the traffic data rate.

In yet another example embodiment, a non-transitory machine-readable medium may comprise executable instructions that, when executed by a processor of a source user equipment, facilitate performance of operations, comprising receiving, from a destination user equipment, a sidelink connection request comprising a request that the source user equipment transmit traffic to the destination user equipment, and determining a sidelink communication route between the source user equipment and the destination user equipment to result in a determined sidelink communication route, wherein the determined sidelink communication route comprises a relay user equipment as a node, a first sidelink communication link between the source user equipment and the relay user equipment, and a second sidelink communication link between the relay user equipment and the destination user equipment. The operations may further comprise determining an end-to-end latency target corresponding to transmission of the traffic by the source user equipment and arrival of the traffic at the destination user equipment to result in a determined end-to-end latency. Based on the determined end-to-end latency, the operations may further comprise determining a sidelink configuration, wherein the sidelink configuration comprises an allowable relay link latency corresponding to the second sidelink communication link, to be used by the relay user equipment to determine a frequency range to use to transmit the traffic to the destination user equipment via the second sidelink communication link. In an embodiment, the sidelink configuration may comprise a source transmission occasion indication indicative of a transmission occasion to be used by the source user equipment to transmit, by the source user equipment to the relay user equipment, the traffic, and the sidelink configuration may comprise at least one timing parameter value to be used by the relay user equipment to determine the frequency range to use to transmit the traffic to the destination user equipment via the second sidelink communication link. The operations may further comprise transmitting the sidelink configuration to the relay user equipment; and transmitting the traffic to the relay user equipment according to the transmission occasion.

In an embodiment, the at least one timing parameter value to be used by the relay user equipment to determine the frequency range to use to transmit the traffic to the destination user equipment via the second sidelink communication link may comprise at least one of: a source transmission time corresponding to transmission time of the traffic from the source user equipment to the relay user equipment, a relay transmission start time offset duration relative to the source transmission time during which the relay user equipment is to begin transmission of the traffic to the destination user equipment, a relay transmission duration during which the relay user equipment is to complete transmission of the traffic to the destination user equipment, or a data rate criterion to be used by the relay user equipment in transmitting the traffic to the destination user equipment.

### BRIEF DESCRIPTION OF THE DRAWINGS

FIG. 1 illustrates a wireless communication system environment.

FIG. 2 illustrates an example environment with multiple user equipment.

FIG. 3A illustrates an example single-hop sidelink forwarding of a sidelink configured grant configuration request.

FIG. 3B illustrates an example multi-hop sidelink forwarding of a sidelink configured grant configuration request.

FIG. 4 illustrates an example scheduling of configured grant resources for sidelink devices.

FIG. 5 illustrates an example sidelink configured grant configuration request.

FIG. 6 illustrates a timing diagram of an example method to schedule configured grant resources usable by user equipment of a sidelink group of user equipment.

FIG. 7 illustrates a flow diagram of an example method to schedule and use configured grant resource by user equipment of a sidelink group of user equipment.

FIG. 8 illustrates a flow diagram of another example method to schedule and use configured grant resource by user equipment of a sidelink group of user equipment.

FIG. 9 illustrates a block diagram of an example method.

FIG. 10 illustrates a block diagram of an example user equipment.

FIG. 11 illustrates a block diagram of an example non-transitory machine-readable medium embodiment.

FIG. 12 illustrates an example computer environment.

FIG. 13 illustrates a block diagram of an example wireless UE.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

### Configured Grant Scheduling (“CG” Scheduling)

CG scheduling is a type of uplink resource scheduling that may optimize minimum latency scheduling to facilitate latency-stringent traffic arrivals at a transmitting device. With CG scheduling, a radio access network node may semi-statically configure periodic resource sets, or resource occasions, for devices to adopt to transmit latency-stringent uplink traffic arrivals. A CG resource set typically comprises configured frequency resources, assigned for a configured duration, repeated periodically to facilitate uplink traffic transmission. When latency-critical, or latency-stringent, traffic arrives at a device for transmission, the device configured with configured grant resources can immediately transmit the traffic during a next available one or more configured CG occasions. Using CG resources, delay while requesting and being granted resources by a radio access network node, for example, may be avoided because the device with traffic to transmit need not buffering the traffic while requesting a scheduling grant that indicates how much uplink traffic is to be transmitted, receiving a resource grant, and transmitting the uplink traffic.

CG scheduling may facilitate fast transmission of uplink packets with less control overhead. However, CG scheduling functions best when a packet arrival rate at a device is almost periodic. For example, to achieve high spectral efficiency, a radio access network node may align a CG resource occasion periodicity corresponding to a device with an expected packet arrival rate corresponding to traffic expected to be received by the device. Thus, CG resource sets or occasions may facilitate spectrally efficient transmission of uplink traffic. Furthermore, a CG resource set or occasion can be dedicated, or granted, to a single user equipment device or may be shared among multiple active user equipment devices, where each is be assigned an orthogonal scrambling code or preamble with which to modulate traffic. Scrambling codes or preambles may facilitate more than a single user equipment device transmitting respective uplink payload simultaneously via the same CG resource occasion. Thus, with orthogonal preamble modulation of traffic corresponding to different user equipment devices, a radio access network node may still be able to distinguish and decode traffic streams received from the different transmitting devices.

### Sidelink Communications

Sidelink communications refers to cellular devices communicating with each other directly, without having to go through a serving RAN node, by establishing a sidelink communication link. However, a RAN node may or may not control how sidelink resources are being reserved and dictated by different sidelink devices. In one sidelink radio resource management option, sidelink devices are configured to always request a sidelink resource towards another sidelink device from the serving RAN node. This requires that at least, the transmitting sidelink node to be within the coverage of the serving node. Furthermore, the sidelink-experienced communication latency clearly increases due to the additional transmission of the RAN scheduling request and reception of the corresponding scheduling grant before the sidelink scheduling and transmission are triggered. Advantageously, this reduces the possibility of sidelink channel collisions.

In another radio resource management option, sidelink devices are configured to autonomously sense the sidelink channel resources, determine which sidelink resource are reserved for other devices' sidelink transmissions, and determine which resource set is free/available for their own transmission. The channel sensing rules and high-level channel sensing configurations are indicated from the RAN network. Therefore, the sidelink control channel has been designed to support efficient channel sensing over the sidelink interface. In particular, the sidelink control channel is designed in a two-stage format. The first stage carries a first stage sidelink control information (“SCI”), and the second stage carries a second stage SCI.

The first stage SCI is similar to the RAN downlink control information (“DCI”) and may carry the following information elements: scheduling information of a reserved data resource for a sidelink transmission of interest, and scheduling resource information of the second stage SCI that carries the transmission-specific configuration of the sidelink data channels.

Accordingly, sidelink devices attempt blindly decoding of the first stage SCI to determine which sidelink data resource will be reserved by which sidelink device in proximity. However, the sensing sidelink device cannot determine whether an actual sidelink data payload is destined for it, thus a sidelink device decodes the second stage SCI. The second stage SCI carries the following information elements: source device and destination device identifiers of the sidelink transmission, and sidelink transmission configurations including modulation schemes, coding schemes, and HARQ feedback information.

Therefore, a sidelink device monitors and blindly decodes the first stage SCI to determine the reserved channel resources for the associated sidelink transmission, determines transmission configurations of the second stage SCI, and decodes the second stage SCI to determine if a corresponding sidelink transmission is destined for it. If a sidelink device is a transmit-only device (e.g., an M2M device), the device need only receive and blindly decode the first stage SCI, while skipping decoding of the second stage SCI, in which case channel sensing may only comprise monitoring, detection, and blind decoding of the first stage SCI.

There are two modes of channel sensing. First, continuous channel sensing may be configured such that a control channel of the sidelink interface signaling can flexibly be placed at any time instant such that a sensing sidelink device needs to always search and monitor for a control channel that is carrying the first stage SCI. Second, and due to the significant power consumption burden of the continuous sensing, a partial channel sensing procedure may be implemented, such that the sidelink control channel is configured to be periodically, or non-periodically, transmitted during predefined time instants, or occasions, and accordingly, sensing sidelink device need only monitor and blindly decode those timing and frequency instants while possibly deep sleeping otherwise.

Sidelink relays are sidelink user equipment devices that perform sidelink and RAN functions on behalf of, or for the sake of, other remote sidelink devices in proximity to the sidelink relay. A multi-hop sidelink path, or sidelink route, from a source user equipment to a destination user equipment may comprise multiple sidelink relay user equipment devices. Sidelink relays offer a wide set of sidelink functionality for remote, or destination, sidelink devices including channel granting, multi-hop traffic relaying, or paging monitoring. Thus, less capable sidelink remote devices obtain several performance advantages such as power saving gains, and sidelink and RAN network coverage extension. Two modes may be used by a sidelink relay device to announce presence with respect to other sidelink user equipment in proximity. In one variant, sidelink relays explicitly announce their presence using a preconfigured discovery procedure. During the configured discovery period, sidelink relay broadcasts an announcement message that indicates their presence and their associated relaying configurations. Remote/destination devices receive a relay's discovery messages and, upon interest in becoming part of, or a member of, a sidelink zone, or group, that includes the relay, initiate a direct communication link with the sidelink relay.

In another discovery variant, a sidelink remote device proactively transmits a discovery message requesting that sidelink relays in proximity announce their presence and corresponding relaying services. This option offers the advantage of the on-demand discovery signaling where sidelink relays avoid transmitting unnecessary discovery messages that may not be utilized by present remote devices in proximity.

Layer-2 relaying denotes that the end-to-end protocol stack and QoS targets over a sidelink interface will not be interrupted at the relay, e.g., the relay alters lower layer headers to perform traffic relaying. Thus, with layer-2 relays, the end-to-end QoS and flows can be tracked and maintained. However, for layer-3 relaying, the end-to-end QoS is lost at the relay side because the latter alters and translates the original QoS flows metrics to corresponding relay-specific metrics.

Baseline channel allocation procedures corresponding to a sidelink interface are typically dynamic and may depend on either RAN network configurations or sidelink device sensing and resource selection. It may be desirable to utilize limited sidelink resources only when there is sidelink traffic to maximize sidelink spectral efficiency. However, sidelink use may comprise various sidelink device capabilities, sidelink transmission periodicities, and sidelink QoS targets. For example, for sidelink devices that are able to sense a sidelink channel, the reliability of the sidelink interface can be enhanced by using sidelink resources the devices sense as idle. However, for sensing-non-capable sidelink devices, random selection of sidelink channel resources for facilitating sidelink transmission may jeopardize reliability of concurrent sidelink transmission-critical traffic when a resource collision occurs.

Accordingly, sidelink channel preemption procedures may be used to enable sidelink devices with traffic to be transmit that is higher priority than traffic to be transmitted by other sidelink devices to attach or append a higher priority traffic indication, that may be a first stage SCI, to facilitate selecting and ‘taking over’ sidelink resources that may have been assigned for transmission of the lower priority traffic. Thus, user equipment corresponding to higher priority critical traffic can immediately takeover occupied sidelink channel resources and achieve an optimized sidelink transmission latency. User equipment corresponding to lower priority traffic, upon detecting the higher priority traffic indication in the first stage SCI, may stop and/or halt ongoing sidelink transmission over resources scheduled according to the first stage SCI such that a collision is avoided. Although facilitating transmission of higher priority traffic, sidelink channel preemption may result in several drawbacks, including sidelink device with lower priority traffic must be sensing-capable devices, otherwise, they may not detect the higher priority preemption indication, and accordingly, may continue sidelink transmissions over resources scheduled for the user equipment corresponding to the higher priority traffic thus causing a collision, and degrading sidelink latency and reliability. In addition, sidelink channel preemption may not differentiate user equipment corresponding to higher priority traffic on the basis of real time QoS performance. For example, user equipment corresponding to higher priority traffic may transmit the same higher priority traffic preemption indication regardless of which device with high priority traffic may be about to violate a QoS target first, and thus should be prioritized with respect to other devices in proximity.

Accordingly, it is desirable to optimize latency performance and reliability of the sidelink communications when channel-sensing-capable and channel-sensing-non-capable sidelink devices coexist with each other on the same sidelink spectrum. In such deployments, existing sidelink channel allocation and prioritization procedures do not guarantee fast and reliable sidelink transmissions due to the key assumption that sidelink devices in proximity must be able to sense the sidelink channel allocation messages fully or partially, which is not applicable in many sidelink deployments. Thus, solutions for improving sidelink channel reliability and latency in multi-device multi-capability sidelink deployments are desirable.

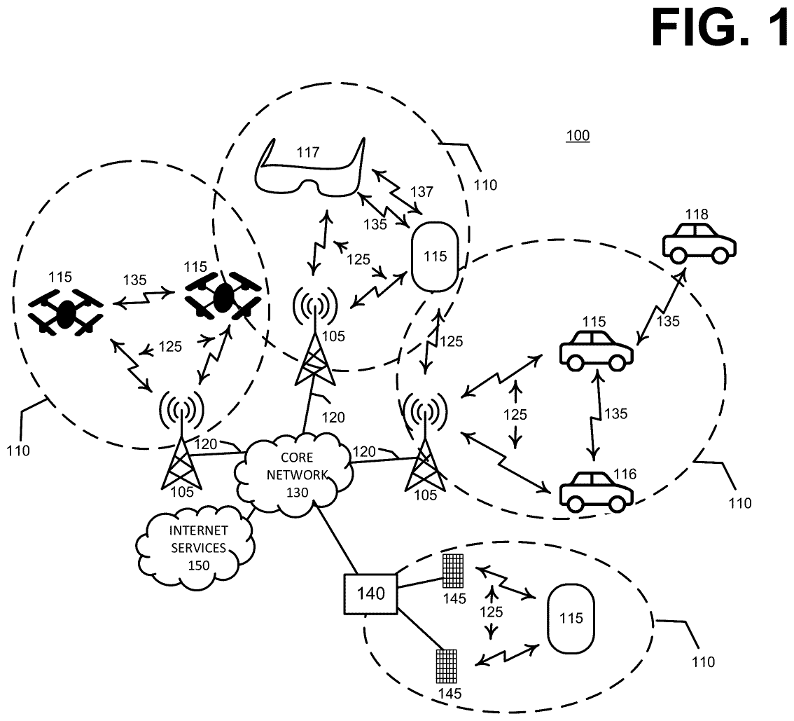

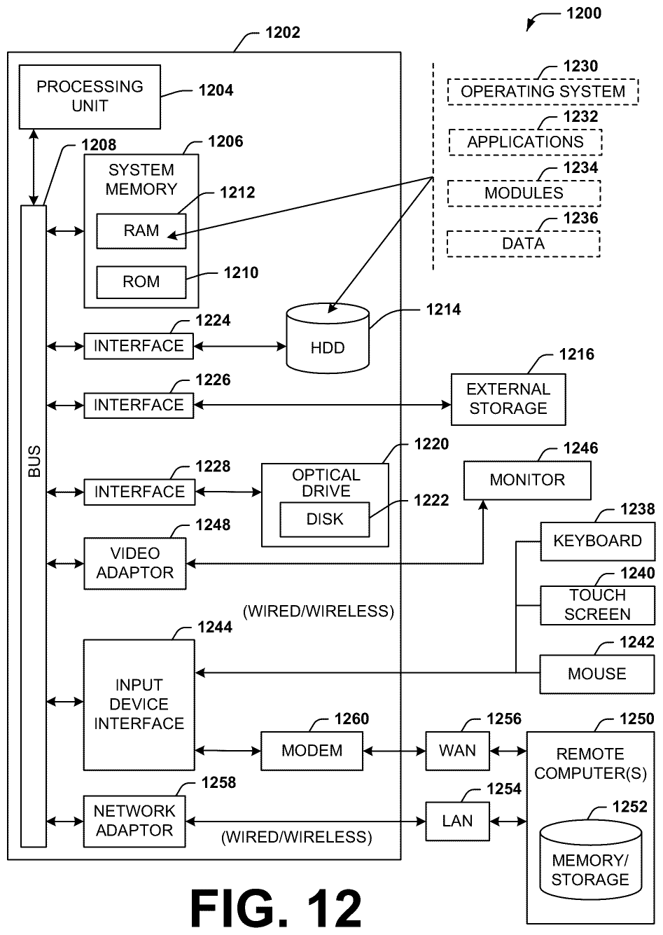

Turning now to the figures, FIG. 1 illustrates an example of a wireless communication system 100 that supports blind decoding of PDCCH candidates or search spaces in accordance with one or more example embodiments of the present disclosure. The wireless communication system 100 may include one or more base stations 105, one or more user equipment (“UE”) devices 115, and core network 130. In some examples, the wireless communication system 100 may comprise a long-range wireless communication network, that comprises, for example, a Long Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, automobiles or other vehicles, or drones or other aircraft. Another example of a UE may be a virtual reality appliance 117, such as smart glasses, a virtual reality headset, an augmented reality headset, and other similar devices that may provide images, video, audio, touch sensation, taste, or smell sensation to a wearer. A UE, such as VR appliance 117, may transmit or receive wireless signals with a RAN base station 105 via a long-range wireless link 125, or the UE/VR appliance may receive or transmit wireless signals via a short-range wireless link 137, which may comprise a wireless link with a UE device 115, such as a Bluetooth link, a Wi-Fi link, and the like. A UE, such as appliance 117, may simultaneously communicate via multiple wireless links, such as over a link 125 with a base station 105 and over a short-range wireless link. VR appliance 117 may also communicate with a wireless UE via a cable, or other wired connection. A RAN, or a component thereof, may be implemented by one or more computer components that may be described in reference to FIG. 12.

Continuing with discussion of FIG. 1, base stations 105 may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications, such as sidelink communication, may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both. In FIG. 1, vehicle UE 116 is shown inside a RAN coverage area and vehicle UE 118 is shown outside the coverage area of the same RAN. Vehicle UE 115 wirelessly connected to the RAN may be a sidelink relay to in-RAN-coverage-range vehicle UE 116 or to out-of-RAN-coverage-range vehicle UE 118.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Conventional configured grant scheduling is a technique to facilitate single-link radio communications between a RAN node and user equipment. Conventional CG scheduling typically uses CG resource occasion predefinitions to achieve latency reduction gains by matching preconfigured CG resources to expected traffic arrivals and channel conditions of device that will be transmitting the traffic. When a user equipment device has latency critical traffic available for transmission, using CG scheduling the device likely has an almost immediate (e.g., in time domain) CG resource opportunity to facilitate almost immediate transmission of just-received traffic payload due to timing of CG resources being matched to expected packet arrival rate. Associated frequency resource sets should be sufficient and large enough, depending on the actual link channel conditions, for transmitting the full available payload during a first scheduled resource occasion without segmentation to facilitate radio latency being significantly reduced.

For sidelink communications involving a remote, or destination, user equipment device communicating with a source device via one or more sidelink devices in between (e.g., via one or more sidelink hops), latency performance gains of using CG scheduling may be highly degraded due to the multiple independent radio links, corresponding to the multiple hops, towards the destination device. Thus, a single intermediate link having a degraded latency or degraded channel condition performance may disrupt CG scheduling operation and may lead to degradation of an end-to-end (e.g., from source user equipment to destination user equipment) transmission performance. Accordingly, CG scheduling coordination among multiple sidelink user equipment of a multi-hop sidelink communication path is desirable.

### Configured Grant Scheduling for a Multi-Hop Sidelink Route

According to embodiments disclosed herein, CG scheduling operations and resources corresponding to sidelink links of a sidelink route/path towards a destination device may be coordinated to satisfy a target end-to-end sidelink latency requirement corresponding to the sidelink path. In embodiments disclosed herein, a source sidelink user equipment may receive a connection establishment request from a far way sidelink remote device, which may be referred to as a destination user equipment. The source user equipment may determine one or more intermediate sidelink relay user equipment devices between the source user equipment and the destination user equipment for relaying traffic from the source user equipment to the destination user equipment. The source user equipment, depending on a traffic type, traffic QoS, or sidelink device service type capabilities corresponding to the source user equipment, relay user equipment, or the destination user equipment, may determine a target end-to-end latency requirement, corresponding to traffic to be delivered to the destination user equipment, to be fulfilled over the entire sidelink path between the source user equipment and the destination user equipment.

Thus, the source user equipment may divide the determined end-to-end latency budget into multiple latency sub-budgets with each latency sub-budget corresponding to a sidelink link of the path towards the destination device. The source user equipment may determine and select a CG resource occasion, or occasions, to satisfy the per-link budget(s). For a certain intermediate link with a certain determined maximum target latency sub-budget, via which relayed sidelink traffic must be fully transmitted and released from a device's buffer(s), a CG resource occasion corresponding to the intermediate link may be determined to start within a certain time offset from the time the traffic has been received at a transmitting device corresponding to the intermediate link (propagation delay may be assumed to be negligible due to proximity of one UE to another in a sidelink scenario) and to be active for a maximum determined CG duration for transmitting the relayed sidelink traffic payload.

Accordingly, the source user equipment device may transmit one or more sidelink CG configuration requests toward each of one or more sidelink relay devices indicating a start time/offset and a requested maximum duration of a CG occasion, which will be used to carry the relayed traffic of the sidelink session over one or more corresponding forward sidelink links respective. A receiving relay device of one or more relay devices of a sidelink path may support and facilitate CG timing information (e.g., start time, periodicity, and duration) received in a CG request. However, only a relay user equipment device may be aware of real time channel conditions corresponding to a forward sidelink link (e.g., a link from the relay device toward a next relay device in a sidelink path or toward a destination user equipment if the relay user equipment is the last user equipment in the forward direction before the destination user equipment), a relay user equipment may determine a frequency resource set sufficient to support and facilitate a requested CG start time and duration. For example, for a sidelink link having poor channel conditions, a relay device corresponding to the poor-condition sidelink link may allocate a large frequency resource set to facilitate a very conservative and reliable traffic transmission to be associated with a requested CG timing configuration, which may be received from another relay user equipment or which may be received from a source user equipment. (It will be appreciated that a relay user equipment can be a source user equipment with respect to another relay user equipment.) Thus, latency sub-budgets corresponding to intermediate sidelink link configured grant occasions may be satisfied and thus an end-to-end latency budget from a source user equipment to a destination user equipment may be satisfied. By relay user equipment dynamically varying, based on channel conditions, allocation of frequency resources for a CG occasion corresponding to a given sidelink link, embodiments disclosed herein facilitate satisfaction of an end-to-end latency budget for sidelink traffic being relayed over multiple sidelink hops while avoiding a source device needing to be aware of quality-of-service and channel conditions corresponding to each of multiple links of a sidechain route from the source user equipment to a destination user equipment. According to embodiments disclosed herein, a source transmitting user equipment may determine and configure timing information (e.g., timing resources) of CG occasions corresponding to different links of a sidelink path to a destination user equipment and, for the different links, corresponding relaying user equipment devices may determine respective frequency resources and append those to the timing resources of the CG occasion (requested by the first transmitting device) to determine a next CG occasion timing and resources request (if there are more than one relay user equipment in a sidelink path in the forward direction toward the destination user equipment) or a final CG occasion timing and resources request (if there is only one more relay user equipment in a sidelink path in the forward direction toward the destination user equipment).

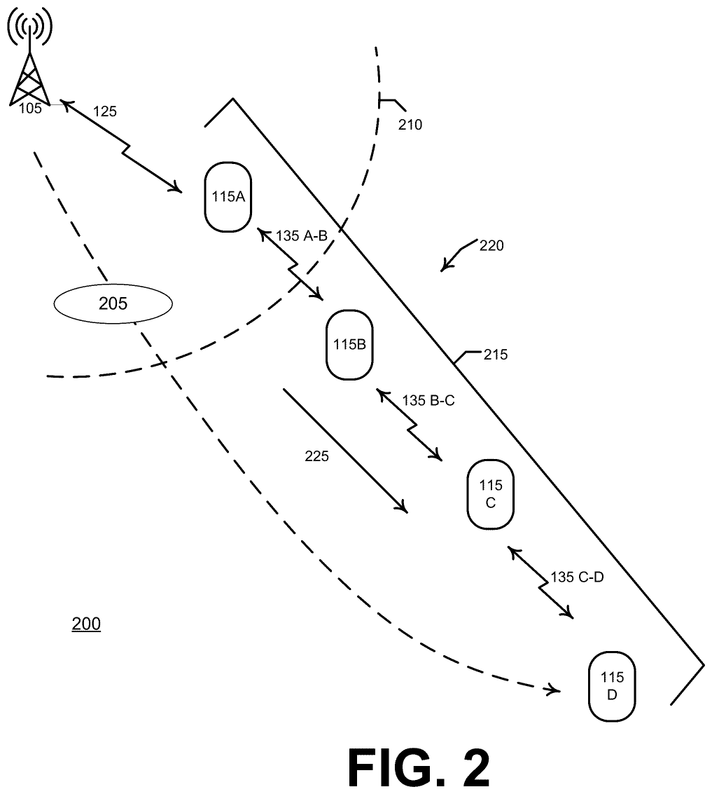

Turning now to FIG. 2, the figure illustrates environment 200 comprising radio access network node 105 with traffic 205 to be delivered to destination user equipment 115D. Because destination user equipment 115D is beyond a radio signal range 210 of radio access network node 105, traffic 205 may be delivered via sidelink route/path 215. Sidelink path 215 may comprise source user equipment 115A, relay user equipment devices 115B and 115C, and destination user equipment 115D. Radio access network node 105 may transmit traffic 205 to source user equipment 115A via long range wireless communication link 125. Traffic 205 may be transmitted from source user equipment 115A to destination user equipment 115D via side link communication links 135. A side link end-to-end latency requirement 220 may correspond to side link path 215. Path 215 may have a forward direction to 225, and may comprise sidelink link 135A-B between source UE 115A and relay UE 115B, sidelink link 135B-C between relay UE 115B and relay UE 115C, and sidelink link 135C-D between relay UE 115C and destination UE 115D.

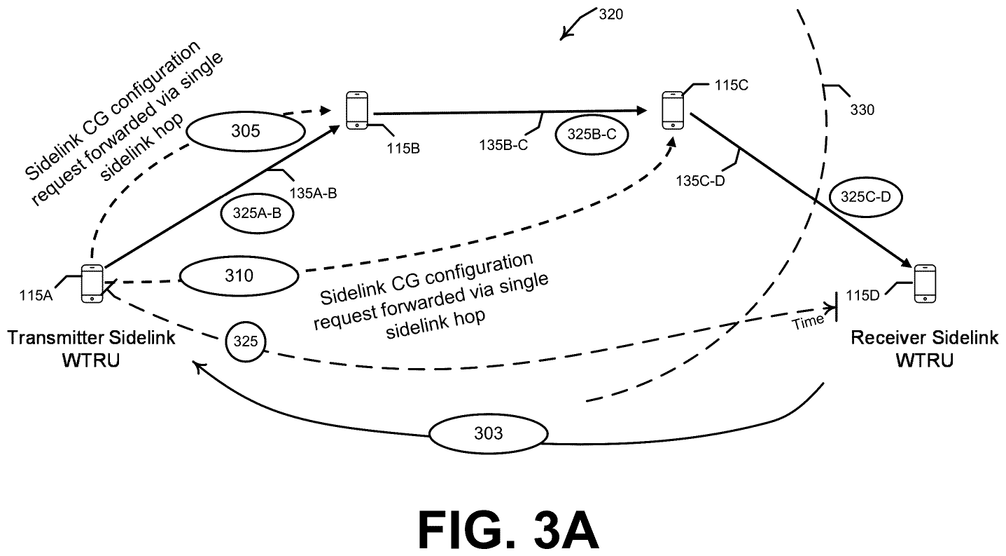

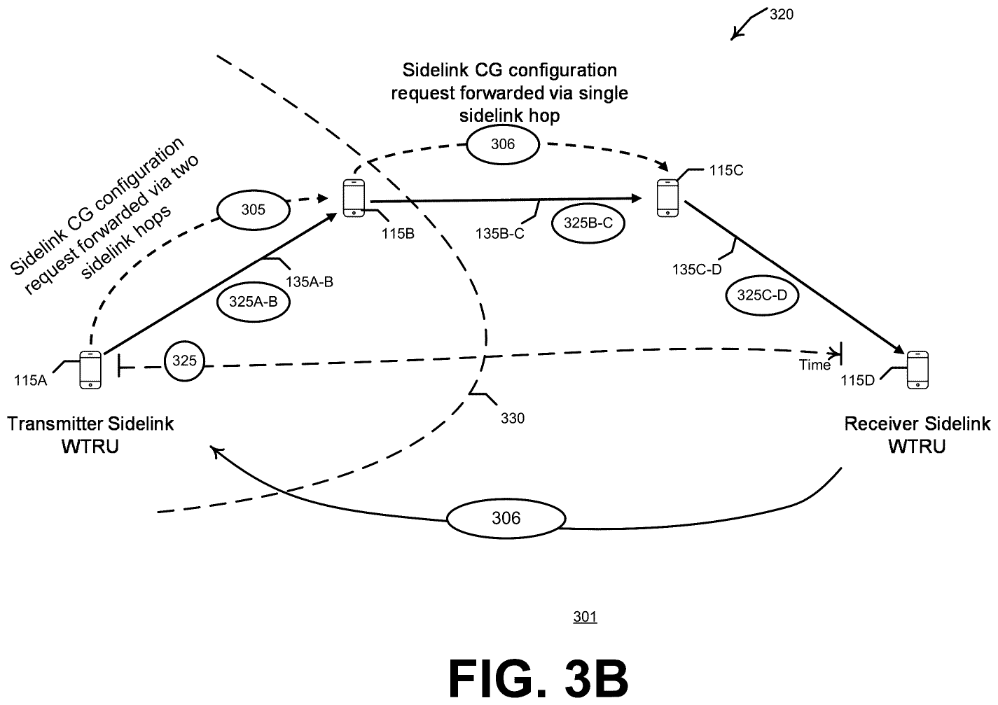

Turning now to FIG. 3A, the figure illustrates an embodiment environment 300 in which source sidelink UE 115A device receives sidelink connection establishment request 303 from remote/destination sidelink user equipment device 115D. In an example, destination UE may be a slave vehicle user equipment, such as a telematics control unit, that may attempt to join an automobile platooning group by requesting connection establishment towards a leader/master telematics user equipment of the platooning group, which may be source user equipment 115A. Destination UE 115D may not need to have information pertaining to a complete sidelink path towards source UE 115A, only information corresponding to sidelink relay 115C, which has information to facilitate directly or indirectly reaching source UE 115A. In such a scenario, source UE 115A manages, or maintains, QoS for the full path from UE 115A to UE 115D because it is the ‘leader’ with information pertaining to a needed QoS and to the traffic to be delivered to UE 115D.

Connection establishment request 303 may comprise sidelink service type information (e.g., type of traffic to be delivered to the destination UE) and remote device radio capability information corresponding to destination UE 115D. Based on the sidelink service type and remote device radio capability information included in request 303, source UE 115A may determine end-to-end quality of service (“QoS”) latency requirement(s) 325 to be applied to delivery of traffic corresponding to request 303. Source UE 115A may determine one or more sidelink relay devices UE 115B and UE 115C to be used as part of sidelink path 320 to relay traffic towards the remote destination UE 115D. Determination of relay devices UE 115B and UE 115C may be based on conventional sidelink routing protocols and techniques.

Source UE 115A may determine and calculate QoS latency sub-budgets 325A-B, 325B-C, and 325C-D, corresponding to hops/links 135A-B, 135B-C, and 135C-D, respectively, with each sub-budget being associated with each single intermediate hop on path 320 towards destination sidelink device 115D. Accordingly, source UE 115A may determine the corresponding per-hop CG scheduling timing requirement(s), which may comprise a per-hop offset or a per hop start time indicative of a time when each respective per-hop CG timing occasion is specified to begin, or a per-hop maximum CG resource duration. Source UE 115A may share per-hop CG timing configurations with each of relay UEs 115B and 115C of path 320 towards remote/destination UE 115D. The per hop configuration requests may be in the form of CG timing configuration requests, which may be referred to herein as sidelink configured grant configuration requests or sidelink configurations.

In an embodiment shown in FIG. 3A, CG timing configuration request 305 may be transmitted as separate sidelink control information (“SCI”) signaling messages from source UE 115A towards each intermediate/relay UE 115B and UE 115C. Such separate transmission of separate configuration requests 305 may be conditioned on relay devices 115B and 115C being within a radio range 330 of source UE 115A such that the source UE can communicate directly with the relay user equipment without using sidelink links 135A-B and 135 B-C.

However, in a scenario, such as environment 301 shown in FIG. 3B, where one or more relay user equipment of a determined sidelink path 320 are not in proximity of source UE 115A (e.g., not within range 330 of UE 115A), a CG timing configuration request may be shared sequentially in a forward direction from one relay UE, such as UE 115B, to another relay UE, such as UE 115C. Thus, source UE 115A may transmit a full CG timing configuration request 305 towards the first reachable relay UE 115B, wherein configuration request 305 comprises all CG timing request information of the forward one or more links 135A-B, 135B-C, and 135C-D. Relay UE 115B may extract CG timing information corresponding to forward links 135B-C and 135C-D and compile a new partial CG timing configuration request 306 that indicates latency sub budget information that should be satisfied by transmission along links 135B-C and 135C-D. Relay UE 115B may transmit new/updated sidelink configured grant configuration request 306 to relay UE 115C. In turn, relay UE 115C may determine, compile, and transmit another partial/new/updated CG timing configuration request towards a next relay device, if any, on the path towards remote destination UE 115D. (In FIG. 3B, there is not another relay user equipment in the forward direction—UE 115D is a destination UE to which traffic is ultimately directed and not a relay UE.)

Since relay user equipment 115B can determine channel conditions corresponding to link 135B-C because user equipment 115B is an endpoint of link 135B-C, and since relay user equipment 115C can determine channel conditions corresponding to link 135-C-D because user equipment 115C is an endpoint of link 135C-D, configuration request 306 may only comprise timing information to ensure traffic is transmitted to satisfy end-to-end latency requirements/latency sub-budget 325C-D, and relay user equipment 115B may determine, or compile, information in request 306 such that relay user equipment 115C can also determine resources needed such that transmission of the traffic from relay user equipment 115C to destination user equipment 115D does not cause a violation of sub-budget latency requirements 325C-D. Relay user equipment 115B may use channel conditions corresponding to link 135B-C to determine latency sub-budget 325B-C, which may then be used to determine sidelink frequency resources to be used by relay user equipment 115B to transmit traffic to relay user equipment 115C. In turn, relay user equipment 115C may use channel conditions corresponding to link 135C-D to determine a latency sub-budget corresponding to link 135C-D, which may then be used by UE 115C to determine frequency resources needed to transmit traffic from relay user equipment 115C to destination user equipment 115D according to timing information received in configured grant request message 306. Accordingly, end-to-end latency requirements 325 may be satisfied by satisfaction of information contained in a combination of sidelink configured grant configuration requests 305 and 306 without source user equipment 115A having awareness of channel conditions corresponding to sidelink link 135B-C or sidelink link 135C-D.

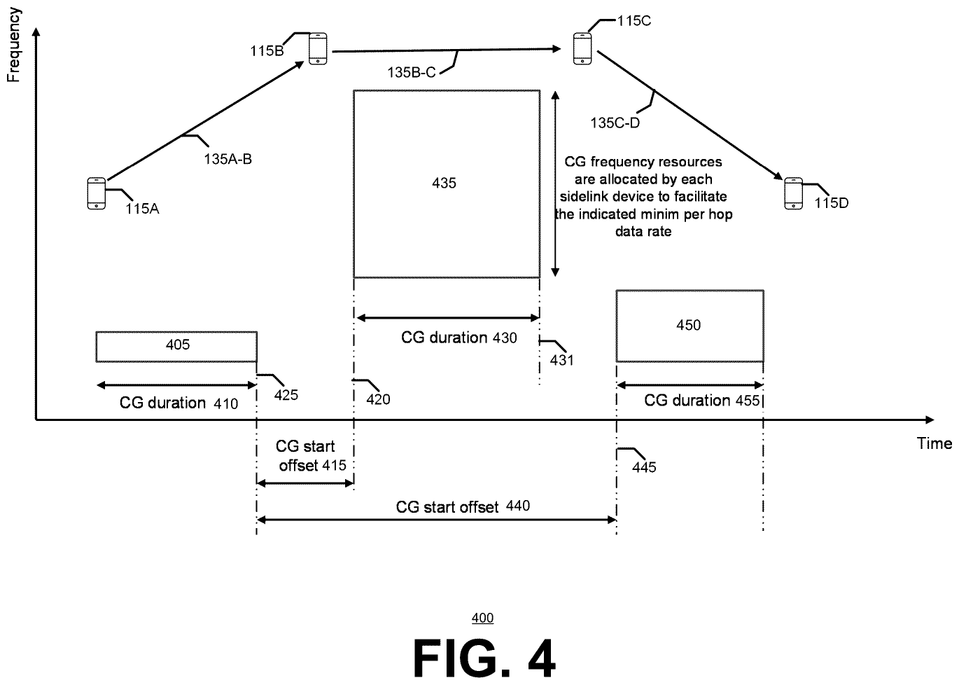

Turning now to FIG. 4, the figure illustrates an example scheduling of configured grant resources for sidelink devices. As shown in FIG. 4, a latency sub-budget corresponding to each sidelink hop may be determined for the purpose of satisfying an overall end-to-end sidelink latency budget between UE 115A and UE 115D, by each relay user equipment 115B and 115C, using respective per-hop timing configuration information corresponding to each forward sidelink hop towards destination UE 115D. For example, a CG timing configuration request, corresponding to each hop and received by a sidelink user equipment, may comprise a CG occasion offset indication, referenced from an end of a first CG occasion corresponding to first sidelink hop, or a CG occasion start time indication, or a corresponding CG occasion maximum duration. Thus, a total allowable end-to-end latency budget is supported by facilitating CG scheduling latency performance over each intermediate hop.

As an example, and in reference to FIG. 3A and FIG. 4, source user equipment 115A may determine an end-to-end latency budget 325 to deliver traffic from user equipment 115A to user equipment 115 D via sidelink links of path 320. Source user equipment 115A may determine to use time or frequency resources 405 during configured grant duration 410, which ends at time 425. Thus, a sidelink configured grant configuration request, for example sidelink configured grant configuration request 305 shown in FIG. 3A, may comprise information indicative to relay user equipment 115B that relaying of traffic received from user equipment 115A must begin within configured grant start offset 415. Based on channel conditions corresponding to sidelink link 135B-C between user equipment 115B and 115C, relay user equipment 115B may determine frequency resources 435 to be used by relay user equipment 115B to transmit traffic to relay user equipment 115C for ultimate transmission to destination user equipment 115 D. Relay user equipment 115B may determine time or frequency resources 435 based on having to begin transmission of the traffic at least by time 420 and having to complete transmission of the traffic by the end of configured grant duration 430, or by end time 431, to satisfy end-to-end latency budget 325 as determined by source UE 115A. Similarly, relay user equipment 115C may determine time or frequency resources 450 based on having to begin transmission of the traffic during offset 440 or at least by time 445 and having to complete transmission of the traffic by the end of configured grant duration 455, to satisfy end-to-end latency budget 325 as determined by source UE 115A. In the example, duration 410, offset 415, offset 440, duration 430, end time 431, start time 445, or duration 455 may be included in a CG configuration request 305. In reference to FIG. 3B, a CG configuration request 306 may comprise duration 455, offset 440, or start time 445, but not duration 430 because UE 115B would have already determined resources 435 to use to ensure, or attempt to ensure, that duration 430, or at least end time 431, is satisfied, thus duration 430 may be immaterial to a determination by UE 115C of resources 450 to use to satisfy relaying of traffic from UE 115C to 115D within duration 455.

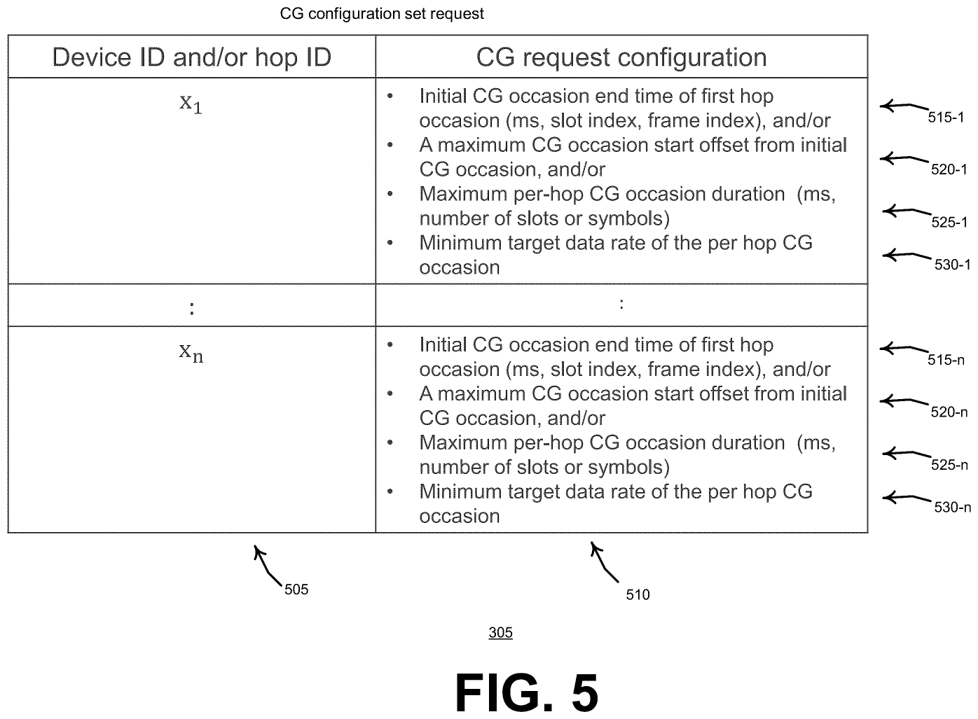

Turning now to FIG. 5, the figure illustrates an example sidelink configured grant resource configuration request, such as a request 305 described in reference to FIG. 3A. Configuration 305 may comprise a user equipment identifier 505, or a forward link identifier indicative of a forward sidelink link corresponding to a user equipment. For example, xi shown in the first row of column 505 shown in FIG. 5 may refer to relay user equipment 115B shown in FIG. 3A, or may refer to link 135B-C. (Source user equipment 115A doesn't need to tell itself what its identifier is, so identifier xi would refer to either the next UE of path 320 or the forward sidelink link 135B-C corresponding thereto.) For each identifier 505, configuration 305 may comprise, as shown in column 510, a first link/hop CG occasion end time 515 (e.g., if xi in column 505 refers to UE 115B, end time 515 may be indicative of end time 431 shown in FIG. 4). Configuration 305 may comprise a hop-specific CG occasion offset time 520 (e.g., for xi in column 505 referring to UE 115B the offset time may correspond to offset 415 shown in FIG. 4), during which the CG occasion duration 430 corresponding to link 135B-C should start. Configuration request 305 may comprise a per hop CG occasion maximum allowable CG occasion duration 525, for example, duration 525-1 in configuration 306 shown in FIG. 5 may be indicative of duration 430 shown in FIG. 4. Configuration 305 may comprise a per-hop target rate indication 530, such as a target minimum data rate or a target minimum packet error rate. A target minimum data rate, for example, may be specified to ensure that a relay user equipment uses a high enough data rate to support a frame rate corresponding to a high-definition camera. A target minimum rate may not be specified if reliability is a requirement.

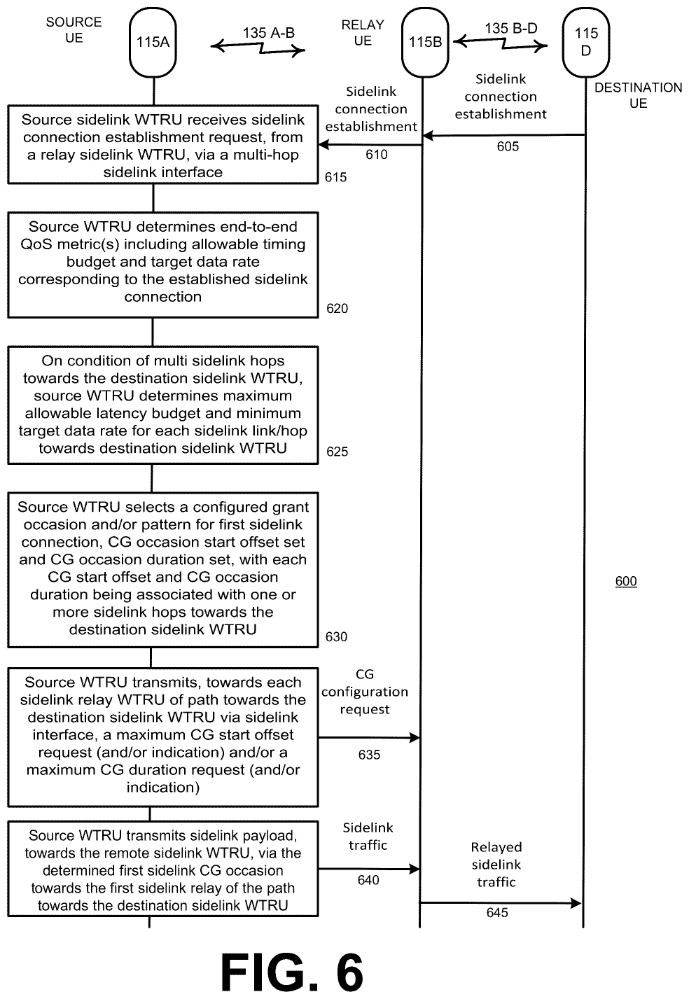

In an example embodiment method represented by timing diagram 600 shown in FIG. 6, remote/destination sidelink user equipment 115D may transmit at act 605 a sidelink connection establishment request via a multi-hop sidelink interface. It will be appreciated that in an embodiment user equipment 115D may be a destination sidelink user equipment, or in another embodiment UE 115D may be a relay user equipment with the term ‘remote’ being used to indicate that the user equipment is remote from source user equipment 115A (e.g., the remote UE is beyond a radio range of source UE 115A and thus an intermediate relay UE is part of a sidelink path between the source UE and the remote UE). In the embodiment shown in FIG. 6, relay user equipment 115B may receive the connection establishment request transmitted at act 605, and at 610 may transmit, or relay, the connection establishment request to source user equipment 115A, which receives the connection establishment request that act 615.

At act 620, source sidelink WTRU 115A may determine an end-to-end quality of service (QoS) performance target (e.g., an end-to-end latency requirement) based on information contained in the connection establishment request. The QoS target may comprise an allowable timing budget or a target data rate to be achieved along a sidelink path that comprises UE 115A, UE 115B, and UE 115D. At act 625, on condition of the side link path between UE 115A in 115D comprising multiple sidelink hops, source UE 115A may determine a maximum allowable latency budget (e.g., a sub-budget) and minimum target data rate to be achieved with respect to each sidelink link/hop towards the remote sidelink UE 115D. At act 630, source sidelink WTRU/UE 115A may select a configured grant occasion and/or pattern corresponding to a first sidelink connection (e.g., a connection/link/hop between UE 115A and UE 115B), a CG occasion start offset set, and a CG occasion duration set corresponding to the link/hop between UE 115B and 115D. It will be appreciated that if UE 115D is a relay user equipment instead of a destination user equipment, a CG occasion start offset set or a CG occasion duration set may comprise offset values and duration values, respectively, corresponding to multiple relay user equipment and associated side link hops, where each CG start offset and associated CG occasion duration are associated with one or more sidelink hops towards a remote sidelink WTRU, which may be a relay UE or the destination UE.

At act 635, source sidelink WTRU may transmit, towards each of one or more sidelink relay WTRUs in the sidelink path towards the remote sidelink WTRU 115D over a sidelink interface, a maximum CG start offset request (and/or indication) and/or a maximum CG duration request (and/or indication). For purposes of illustration, FIG. 6 shows only one relay UE (e.g., UE 115B) between source UE 115A and remote destination UE 115D, but, in an example, multiple relay UEs and multiple corresponding hops could make up a sidelink path between source UE 115A and destination UIE 115D. Thus, if there were three relay user equipment devices between UE 115A and UE 115D in the example, UE 115A may transmit to each of the three relay user equipment at act 635 a sidelink configured grant configuration request message, for example configuration request 305 described in reference to FIG. 4, comprising information based on the end-to-end QoS target determined at act 620.

At act 640, source UE 115A may transmit traffic payload, to UE 115B, via the first sidelink CG occasion determined at act 630. At act 645, relay UE 115B may determine frequency resources to use to transmit the traffic payload to UE 115D such that the traffic payload can be successfully transmitted according to timing information, for example an end time, a duration, or an offset, corresponding to the relay user equipment 115B or corresponding to a sidelink link between UE 115B and UE 115D and based on channel conditions corresponding to the link between UE 115B and UE 115D. If more relay user equipment than relay UE 115B make up a sidelink path between source UE 115A and destination UE 115D, a next relay user equipment alongside the sidelink path may also determine frequency resources to use such that the traffic payload could be successfully transmitted to another relay user equipment or to the destination user equipment in the forward direction according to timing information received at act 635 and based on channel conditions between the next relay user equipment and the user equipment to which the next relay user equipment transmits the traffic payload. Accordingly, without information regarding sidelink link channel conditions, except for channel conditions corresponding to the sidelink link between UE 115A and UE 115B, source UE 115A may determine an end-to-end target latency, determine timing information that if satisfied by relay user equipment in relaying traffic payload should result in the traffic payload reaching a destination user equipment within the end-to-end latency budget, and determination of frequency resources to use to satisfy the per-link timing information is left up to the relay user equipment to determine based on channel conditions between each of the relay user equipment and a next user equipment in the forward direction along the side link path between the source user equipment 115A and the destination user equipment 115D.

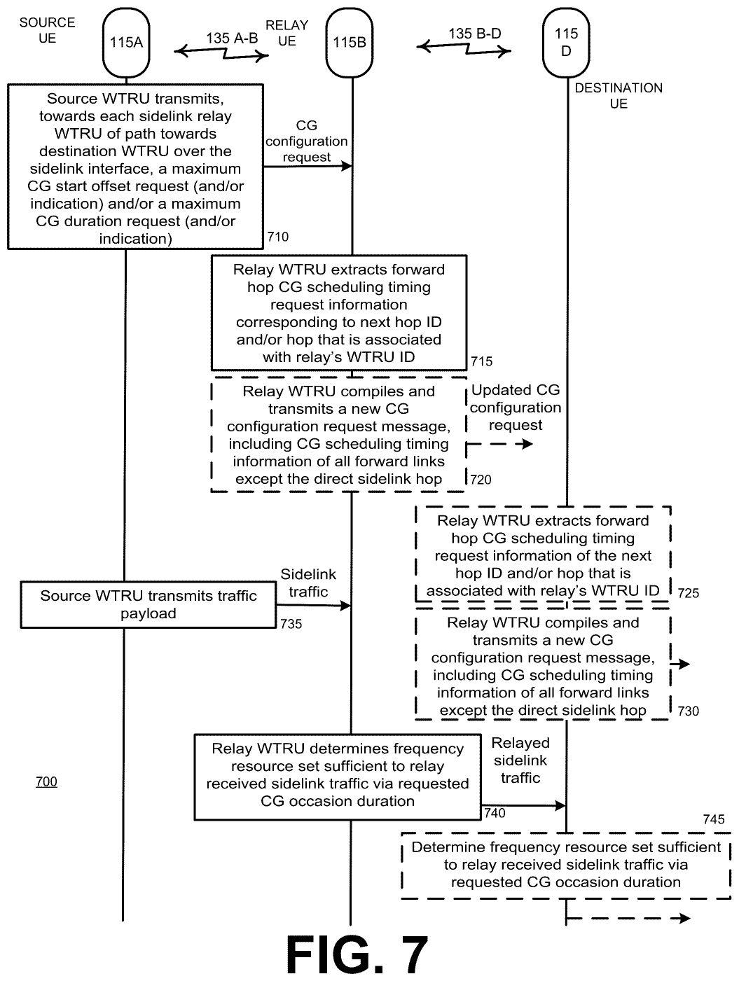

In an example embodiment method represented by timing diagram 700 shown in FIG. 7, after having determined an end-to-end latency for transmission of traffic via side link links 135A-B and 135B-D, at act 710, source user equipment 115A may transmit to relay user equipment 115B timing information to be used by the relay user equipment to transmit the traffic via sidelink link 135B-D such that the end-to-end latency will be satisfied. At act 715, relay user equipment 115B may extract timing information, corresponding to link 135B-D, transmitted by source user equipment 115A at act 710. At act 735, source user equipment 1158 may transmit traffic payload to relay user equipment 115B. At act 740, relay user equipment 115B may determine frequency resources to use to transmit the traffic payload, via sidelink link 135B-D, to user equipment 115D, and may transmit the traffic payload according to the determined frequency resources and according to timing information extracted at act 715 from the configuration request transmitted by the source user equipment 115A at act 710.

In FIG. 7, additional acts are shown in dashed lines that may be applicable if more than one relay user equipment makes up a side link path between source user equipment 115A and destination user equipment 115D. For example, after extracting timing information to be used to relay traffic the sidelink link 135B-D, relay user equipment 115B may generate, or compile, a new sidelink configured grant configuration request message to be applicable to a next relay user equipment if such next relay user equipment makes up part of the path between relay user equipment 115B and destination user equipment 115D, and may transmit at act 720 the new/updated sidelink configured grant configuration request to the next relay user equipment. At act 725, the next relay user equipment may extract timing information to be used for a sidelink link between the next relay user equipment and another user equipment, which could be another relay user equipment or could be destination user equipment 115D. At act 730, the next relay user equipment may compile another new sidelink configured grant configuration request and transmit the other new sidelink configured grant configuration request to another relay user equipment to be used to transmit/relay traffic payload toward destination user equipment 115D. At act 745, the other relay user equipment may determine frequency resources to use to transmit the traffic payload according to the timing information transmitted act 725. The determination at act 745 may be based on channel conditions corresponding to a sidelink link between the other relay user equipment and yet another relay user equipment or between the other relay user equipment and destination user equipment 115D.

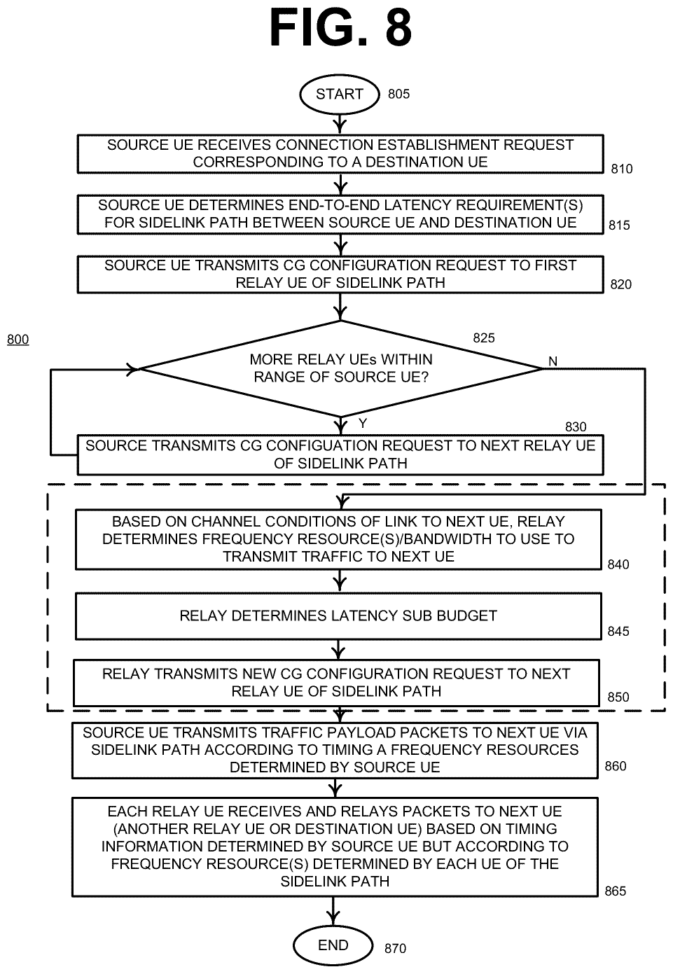

Turning now to FIG. 8, the figure illustrates a flow diagram of an example method 800 to schedule and use configured grant resource occasions by user equipment of a sidelink path, route, chain, group, or set, of user equipment. Method 800 begins at act 805. At act 810, a source user equipment of the side link path may receive a connection establishment request corresponding to a destination user equipment. The source user equipment may receive the connection establishment request from a relay user equipment that is part of the sidelink path between the source user equipment and the destination user equipment. The sidelink path may comprise one, or more than one, relay user equipment between the source user equipment and the destination user equipment. At act 815, the source user equipment may determine an end-to end-latency requirement to be achieved by user equipment of the side link path in transmitting one or more traffic protocol data units (e.g., one or more packets) from the source user equipment to the destination user equipment. The source user equipment may determine the end-to-end latency requirement, or end-to-end latency target, based on information contained in the connection establishment request, for example, type of traffic to be transmitted to the destination user equipment via the sidelink path, or a capability corresponding to the destination user equipment, the source user equipment, or relay user equipment along the sidelink path. At act 820, the source user equipment may transmit a sidelink configured grant configuration request to a relay user equipment of the side link path that is connected to the source user equipment via a sidelink link in a direction toward the destination user equipment along the side link path, which direction may be referred to as a forward direction. A sidelink configured grant configuration request transmitted at act 820 may comprise timing information corresponding to one or more relay user equipment, or corresponding to sidelink links corresponding to a user equipment, that may make up the side link path. An example sidelink configured grant configuration request is described in reference to sidelink configured grant configuration request 305 shown in FIG. 5. Timing information included in a sidelink configured grant configuration request may comprise an end time, an offset time, or a duration that specify to a relay user equipment a period during which a relay user equipment corresponding to the timing information should begin and end transmission/relaying of packets received from a previous user equipment of the side link path to a next user equipment of the side link path in the forward direction. The previous user equipment of the side link path may be the source user equipment, or may be a relay user equipment. The next user equipment of the side link path may be the destination user equipment, or may be another relay user equipment. The timing information may be determined by the source user equipment such that if each relay user equipment of the side link path satisfies the timing information the end-to-end latency requirement for delivering traffic packets from the source user equipment to the destination user equipment should be satisfied.

However, a sidelink configured grant configuration request does not specify frequency or bandwidth resource information corresponding to frequency ranges or bandwidth to be used by a relay user equipment to transmit packets via the side link path. It is up to each relay user equipment of the side link path to determine frequency resources to be used by the relay user equipment based on channel conditions corresponding to a sidelink link between the relay user equipment and a next user equipment (which may be another relay user equipment or the destination user equipment) in a forward direction. For example, if a relay user equipment determines that channel conditions corresponding to a sidelink link between the relay user equipment and a next user equipment in the forward direction are poor, the relay user equipment may grant itself, or request a grant of, a large range of sidelink frequency bandwidth to accommodate a conservative modulation scheme to ensure that packets are successfully transmitted by the relay user equipment to a next user equipment within time constraints indicated to the relay user equipment in the sidelink configured grant configuration request transmitted at act 820.

At act 825, the source user equipment may determine whether additional relay user equipment are within a radio signal range of the source user equipment. If additional relay user equipment are within radio signal range of the source user equipment, the source user equipment may transmit at act 830 a sidelink configured grant configuration request to one of the additional relay user equipment of the side link path. The sidelink configured grant configuration request transmitted at act 830 may be the same sidelink configured grant configuration request transmitted at act 820. Returning to description of act 825, if the source user equipment determines that there are not additional relay user equipment within radio signal range of the source user equipment, method 800 advances to act 840.

At act 840, a relay user equipment that may have been the farthest away in a forward direction along the side link path from the source user equipment that may have received a sidelink configured grant configuration request transmitted at act 830, or that may have been a last relay user equipment to receive a sidelink configured grant configuration request transmitted at act 830 if more than one relay user equipment were within radio signal range of the source user equipment, may determine sidelink frequency resources or bandwidth to use to transmit traffic packets via a sidelink link in the forward direction of the sidelink path to a next user equipment of the sidelink path. The determination at act 840 of sidelink frequency or bandwidth resources to use may be based on channel conditions corresponding to the sidelink link in the forward direction connecting the user equipment and the next user equipment of the side link path.

At act 845, the relay user equipment may determine a latency sub-budget corresponding to a next relay user equipment for the next relay user equipment and subsequent relay user equipment, if any, to use in determining frequency resources to use in transmitting traffic packets towards the destination user equipment. The latency sub-budget may be used by the relay user equipment to determine new timing information, such as an end time, a duration, or an offset relative to transmission of packets corresponding to a configured grant occasion corresponding to the source user equipment. At act 850, the new timing information may be transmitted by the relay user equipment to a next relay user equipment in a new, or updated, sidelink configured grant configuration request. It will be appreciated that the next relay user equipment may perform acts 840-850 if the sidelink path comprises another next relay user equipment, and that other next relay user equipment may also perform acts 840-850. Accordingly, acts 840-850 are surrounded by a box rendered with dashed lines in FIG. 8 to indicate that if more than one relay user equipment makes up a side link path between a source user equipment and a destination user equipment, relay user equipment that are beyond a radio range of the source user equipment, and thus may not receive the sidelink configured grant configuration request transmitted at act 820, may perform steps 840-850.

At act 860, the source user equipment may transmit traffic payload packets to a next user equipment via the sidelink path according to timing and frequency resources determined by the source user equipment based on information contained in the establishment request message received at act 810. The next user equipment to which the source user transmits the payload packets at act 860 may be a relay user equipment. At act 865, the relay user equipment to which the source user equipment transmitted packets at 860 may receive the payload packets and may relay the traffic packets to a next user equipment, which may be another relay user equipment or may be the destination user equipment, based on timing information determined by the source user equipment but according to frequency resources determined by the relay user equipment to which the source user equipment transmitted the packets at act 860. The timing information used at act 865 may have been received in a sidelink configured grant configuration request transmitted by the source user equipment at act 820, or the timing information used act 865 may have been received from a relay user equipment in a new, or updated, sidelink configured grant configuration request, as described in reference to acts 845-850. Thus, a relay user equipment of a side link path between a source user equipment and a destination user equipment may detect and determine channel conditions corresponding to a sidelink link between the relay user equipment and a next user equipment, whether the next user equipment is another relay user equipment or the destination user equipment, and may determine frequency resources to use to transmit traffic to the next user equipment such that timing information contained in a sidelink configured grant configuration request received either from the source user equipment or from another relay user equipment is satisfied. Method 800 advances to act 870 and ends.

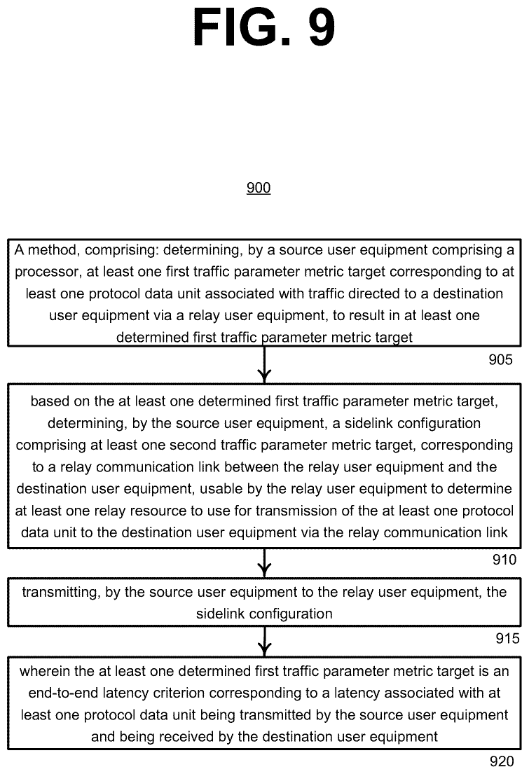

Turning now to FIG. 9, the figure illustrates an example embodiment method 900 comprising at block 905 determining, by a source user equipment comprising a processor, at least one first traffic parameter metric target corresponding to at least one protocol data unit associated with traffic directed to a destination user equipment via a relay user equipment, to result in at least one determined first traffic parameter metric target, at block 910 based on the at least one determined first traffic parameter metric target, determining, by the source user equipment, a sidelink configuration comprising at least one second traffic parameter metric target, corresponding to a relay communication link between the relay user equipment and the destination user equipment, usable by the relay user equipment to determine at least one relay resource to use for transmission of the at least one protocol data unit to the destination user equipment via the relay communication link; at block 915 transmitting, by the source user equipment to the relay user equipment, the sidelink configuration; and at block 920 wherein the at least one determined first traffic parameter metric target is an end-to-end latency criterion corresponding to a latency associated with at least one protocol data unit being transmitted by the source user equipment and being received by the destination user equipment.

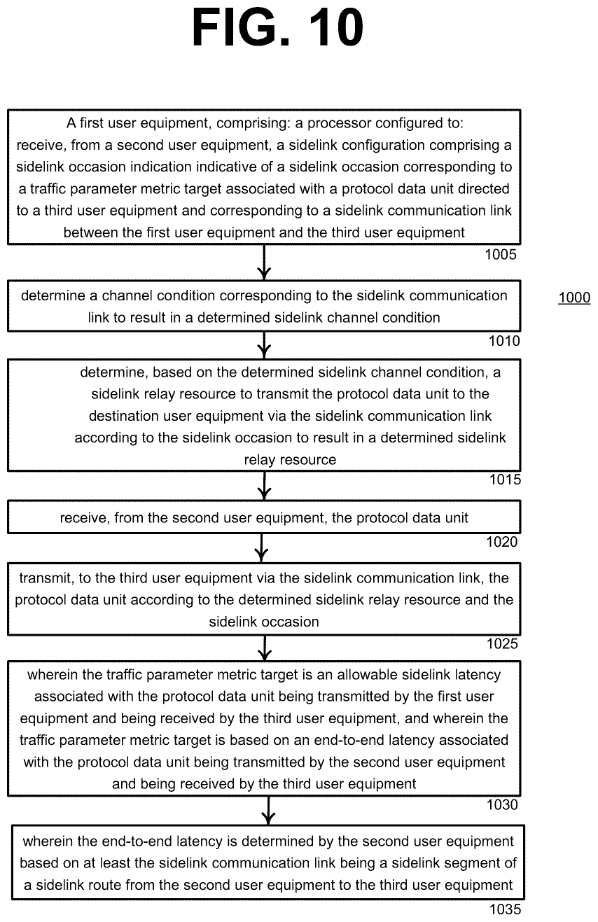

Turning now to FIG. 10, the figure illustrates an example first user equipment 1000 comprising at block 1005 a processor configured to receive, from a second user equipment, a sidelink configuration comprising a sidelink occasion indication indicative of a sidelink occasion corresponding to a traffic parameter metric target associated with a protocol data unit directed to a third user equipment and corresponding to a sidelink communication link between the first user equipment and the third user equipment; at block 1010 determine a channel condition corresponding to the sidelink communication link to result in a determined sidelink channel condition; at block 1015 determine, based on the determined sidelink channel condition, a sidelink relay resource to transmit the protocol data unit to the destination user equipment via the sidelink communication link according to the sidelink occasion to result in a determined sidelink relay resource, at block 1020 receive, from the second user equipment, the protocol data unit; at block 1025 transmit, to the third user equipment via the sidelink communication link, the protocol data unit according to the determined sidelink relay resource and the sidelink occasion; at block 1030 wherein the traffic parameter metric target is an allowable sidelink latency associated with the protocol data unit being transmitted by the first user equipment and being received by the third user equipment, and wherein the traffic parameter metric target is based on an end-to-end latency associated with the protocol data unit being transmitted by the second user equipment and being received by the third user equipment; and at block 1035 wherein the end-to-end latency is determined by the second user equipment based on at least the sidelink communication link being a sidelink segment of a sidelink route from the second user equipment to the third user equipment.

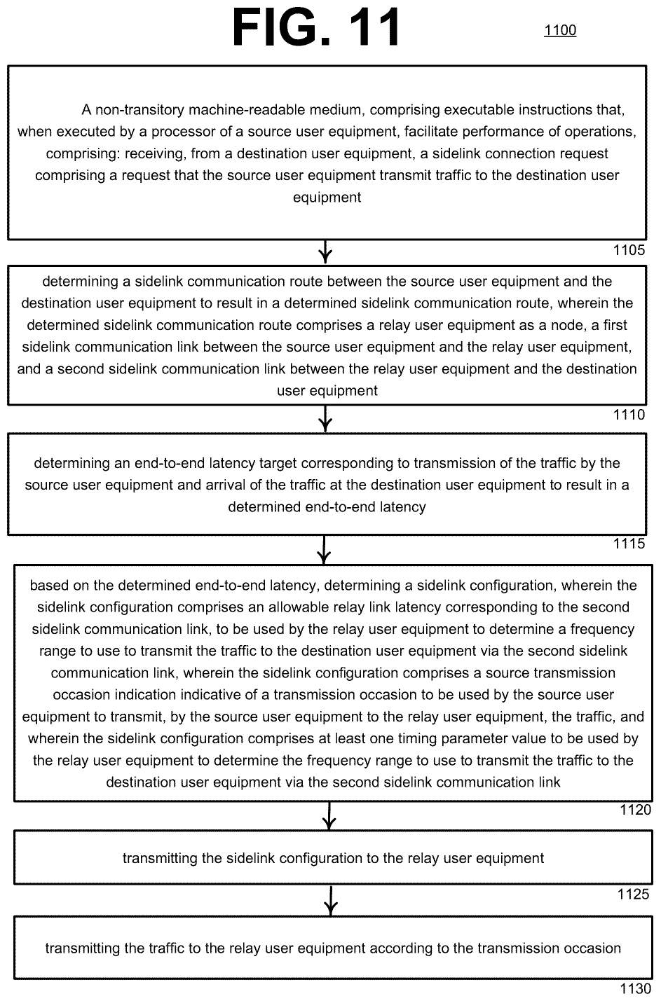

Turning now to FIG. 11, the figure illustrates a non-transitory machine-readable medium 1100 comprising at block 1105 executable instructions that, when executed by a processor of a source user equipment, facilitate performance of operations, comprising: receiving, from a destination user equipment, a sidelink connection request comprising a request that the source user equipment transmit traffic to the destination user equipment; at block 1110 determining a sidelink communication route between the source user equipment and the destination user equipment to result in a determined sidelink communication route, wherein the determined sidelink communication route comprises a relay user equipment as a node, a first sidelink communication link between the source user equipment and the relay user equipment, and a second sidelink communication link between the relay user equipment and the destination user equipment; at block 1015 determining an end-to-end latency target corresponding to transmission of the traffic by the source user equipment and arrival of the traffic at the destination user equipment to result in a determined end-to-end latency; at block 1020 based on the determined end-to-end latency, determining a sidelink configuration, wherein the sidelink configuration comprises an allowable relay link latency corresponding to the second sidelink communication link, to be used by the relay user equipment to determine a frequency range to use to transmit the traffic to the destination user equipment via the second sidelink communication link, wherein the sidelink configuration comprises a source transmission occasion indication indicative of a transmission occasion to be used by the source user equipment to transmit, by the source user equipment to the relay user equipment, the traffic, and wherein the sidelink configuration comprises at least one timing parameter value to be used by the relay user equipment to determine the frequency range to use to transmit the traffic to the destination user equipment via the second sidelink communication link; at block 1025 transmitting the sidelink configuration to the relay user equipment; and at block 1030 transmitting the traffic to the relay user equipment according to the transmission occasion.

In order to provide additional context for various embodiments described herein, FIG. 12 and the following discussion are intended to provide a brief, general description of a suitable computing environment 1200 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors and may include a cache memory. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

Computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid-state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can comprise a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

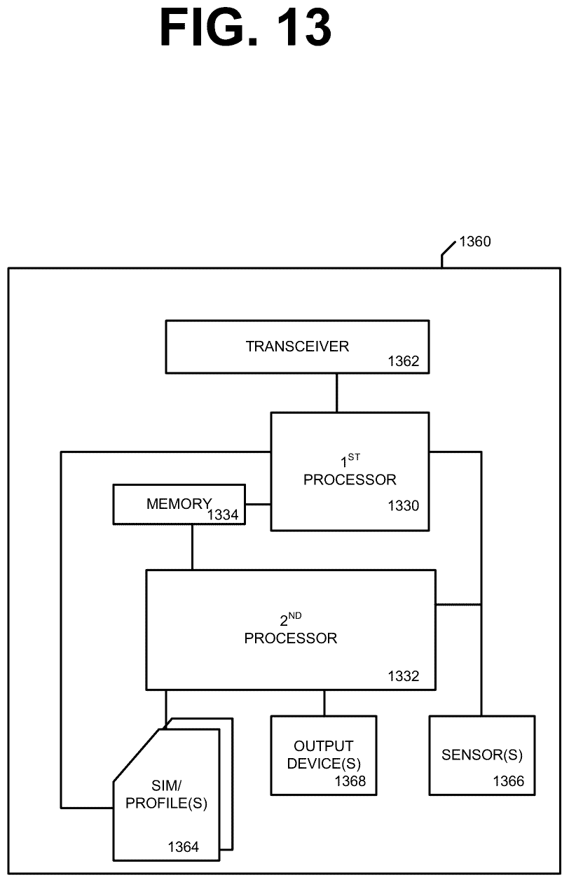

Turning now to FIG. 13, the figure illustrates a block diagram of an example UE 1360. UE 1360 may comprise a smart phone, a wireless tablet, a laptop computer with wireless capability, a wearable device, a machine device that may facilitate vehicle telematics, and the like. UE 1360 comprises a first processor 1330, a second processor 1332, and a shared memory 1334. UE 1360 includes radio front end circuitry 1362, which may be referred to herein as a transceiver, but is understood to typically include transceiver circuitry, separate filters, and separate antennas for facilitating transmission and receiving of signals over a wireless link, such as one or more wireless links 125, 135, or 137 shown in FIG. 1. Furthermore, transceiver 1362 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 13, UE 1360 may also include a SIM 1364, or a SIM profile, which may comprise information stored in a memory (memory 34 or a separate memory portion), for facilitating wireless communication with RAN 105 or core network 130 shown in FIG. 1. FIG. 13 shows SIM 1364 as a single component in the shape of a conventional SIM card, but it will be appreciated that SIM 1364 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 1364 and another device, which may be a component of RAN 105 or core network 130 shown in FIG. 1). A SIM profile 1364 may also comprise identifying information that is unique to the SIM, or SIM profile, such as, for example, an International Mobile Subscriber Identity (“IMSI”) or information that may make up an IMSI.

SIM 1364 is shown coupled to both the first processor portion 1330 and the second processor portion 1332. Such an implementation may provide an advantage that first processor portion 30 may not need to request or receive information or data from SIM 1364 that second processor 1332 may request, thus eliminating the use of the first processor acting as a ‘go-between’ when the second processor uses information from the SIM in performing its functions and in executing applications. First processor 1330, which may be a modem processor or baseband processor, is shown smaller than processor 1332, which may be a more sophisticated application processor, to visually indicate the relative levels of sophistication (i.e., processing capability and performance) and corresponding relative levels of operating power consumption levels between the two processor portions. Keeping the second processor portion 1332 asleep/inactive/in a low power state when UE 1360 does not need it for executing applications and processing data related to an application provides an advantage of reducing power consumption when the UE only needs to use the first processor portion 1330 while in listening mode for monitoring routine configured bearer management and mobility management/maintenance procedures, or for monitoring search spaces that the UE has been configured to monitor while the second processor portion remains inactive/asleep.

UE 1360 may also include sensors 1366, such as, for example, temperature sensors, accelerometers, gyroscopes, barometers, moisture sensors, and the like that may provide signals to the first processor 1330 or second processor 1332. Output devices 1368 may comprise, for example, one or more visual displays (e.g., computer monitors, VR appliances, and the like), acoustic transducers, such as speakers or microphones, vibration components, and the like. Output devices 1368 may comprise software that interfaces with output devices, for example, visual displays, speakers, microphones, touch sensation devices, smell or taste devices, and the like, that are external to UE 1360.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| DRX | Discontinuous reception |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| UE | User equipment |
| WTRU | Wireless transmit receive unit |
| URLLC | Ultra reliable and low latency communication |
| CBR | Channel busy ratio |
| SCI | Sidelink control information |
| SBFD | Sub-band full duplex |
| CLI | Cross link interference |
| TDD | Time division duplexing |
| FDD | Frequency division duplexing |
| BS | Base-station |
| RS | Reference signal |
| CSI-RS | Channel state information reference signal |
| PTRS | Phase tracking reference signal |
| DMRS | Demodulation reference signal |
| BS | Base-station |
| gNB | General NodeB |
| PUCCH | Physical uplink control channel |
| PUSCH | Physical uplink shared channel |
| SRS | Sounding reference signal |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
determining, by a source user equipment comprising a processor, at least one first traffic parameter metric target corresponding to at least one protocol data unit associated with traffic directed to a destination user equipment via a relay user equipment, to result in at least one determined first traffic parameter metric target;
based on the at least one determined first traffic parameter metric target, determining, by the source user equipment, a sidelink configuration comprising at least one second traffic parameter metric target, corresponding to a relay communication link between the relay user equipment and the destination user equipment, usable by the relay user equipment to determine at least one relay resource to use for transmission of the at least one protocol data unit to the destination user equipment via the relay communication link; and
transmitting, by the source user equipment to the relay user equipment, the sidelink configuration.

2. The method of claim 1, wherein the at least one determined first traffic parameter metric target is an end-to-end latency criterion corresponding to a latency associated with at least one protocol data unit being transmitted by the source user equipment and being received by the destination user equipment.

3. The method of claim 1, wherein the at least one second traffic parameter metric target comprises a time parameter metric target.

4. The method of claim 3, wherein the time parameter metric target comprises a relay resource occasion indication indicative of a relay resource occasion to transmit, by the relay user equipment to the destination user equipment, the at least one protocol data unit.

5. The method of claim 4, wherein the at least one relay resource corresponds to a frequency range usable by the relay user equipment to transmit the at least one protocol data unit during the relay resource occasion.

6. The method of claim 4, wherein the relay resource occasion indication is at least one of: a relay resource occasion start time indication indicative of a latest start time corresponding to the relay resource occasion, a relay resource occasion end time indication indicative of a latest end time corresponding to the relay resource occasion, or a relay resource occasion duration indication indicative of a maximum duration corresponding to the relay resource occasion.

7. The method of claim 6, wherein the relay resource occasion start time indication is indicative of an offset from a transmit time corresponding to the at least one protocol data unit being transmitted, by the source user equipment, to the destination user equipment.

8. The method of claim 1, wherein the relay user equipment is a first relay user equipment, wherein the relay communication link is a first relay communication link, wherein the at least one relay resource is at least one first relay resource, and wherein the sidelink configuration further comprises at least one third traffic parameter metric target, corresponding to a second relay communication link between a second relay user equipment and the destination user equipment, usable by the second relay user equipment to determine at least one second relay resource to use to transmit the traffic to the destination user equipment via the second relay communication link.

9. The method of claim 8, wherein the sidelink configuration is transmitted by the first relay user equipment to the second relay user equipment.

10. The method of claim 8, further comprising:
transmitting, by the source user equipment to the second relay user equipment, the sidelink configuration.

11. The method of claim 8, wherein the sidelink configuration is determined by the source user equipment based on the at least one determined first traffic parameter metric target.

12. The method of claim 1, wherein the relay user equipment is a first relay user equipment, wherein the source user equipment is a second relay user equipment, wherein the relay communication link is a first relay communication link, wherein the at least one relay resource is at least one first relay resource, wherein the transmission of the at least one protocol data unit is a first transmission, and wherein the sidelink configuration is a modified sidelink configuration, the method further comprising:
receiving, by the second relay user equipment from a third relay user equipment, a source sidelink configuration that comprises the at least one second traffic parameter metric target and at least one third traffic parameter metric target, corresponding to a second relay communication link between the third relay user equipment and the second relay user equipment, usable by the second relay user equipment to determine at least one second relay resource to use for a second transmission of the at least one protocol data unit to the destination user equipment via the second relay communication link;
based on the at least one determined first traffic parameter metric target, determining, by the second relay user equipment, the at least one second relay resource to use for the second transmission of the at least one protocol data unit to the first relay user equipment via the second relay communication link; and
transmitting, by the second relay user equipment to the first relay user equipment, the modified sidelink configuration for use by the first relay user equipment in determining the at least one first relay resource.

13. The method of claim 12, wherein the at least one first relay resource is to be determined by the first relay user equipment based on a first channel condition metric corresponding to the first relay communication link, and wherein the at least one second relay resource is to be determined by the second relay user equipment based on a second channel condition metric corresponding to the second relay communication link.

14. The method of claim 1, wherein the at least one second traffic parameter metric target comprises a minimum data rate corresponding to the transmission of the at least one protocol data unit, by the relay user equipment to the destination user equipment, via the relay communication link.

15. A first user equipment, comprising:
a processor configured to:
receive, from a second user equipment, a sidelink configuration comprising a sidelink occasion indication indicative of a sidelink occasion corresponding to a traffic parameter metric target associated with a protocol data unit directed to a third user equipment and corresponding to a sidelink communication link between the first user equipment and the third user equipment;
determine a channel condition corresponding to the sidelink communication link to result in a determined sidelink channel condition;
determine, based on the determined sidelink channel condition, a sidelink relay resource to transmit the protocol data unit to the destination user equipment via the sidelink communication link according to the sidelink occasion to result in a determined sidelink relay resource;
receive, from the second user equipment, the protocol data unit; and
transmit, to the third user equipment via the sidelink communication link, the protocol data unit according to the determined sidelink relay resource and the sidelink occasion.

16. The first user equipment of claim 15, wherein the traffic parameter metric target is an allowable sidelink latency associated with the protocol data unit being transmitted by the first user equipment and being received by the third user equipment, and wherein the traffic parameter metric target is based on an end-to-end latency associated with the protocol data unit being transmitted by the second user equipment and being received by the third user equipment.

17. The first user equipment of claim 16, wherein the end-to-end latency is determined by the second user equipment based on at least the sidelink communication link being a sidelink segment of a sidelink route from the second user equipment to the third user equipment.

18. The first user equipment of claim 15, wherein the sidelink configuration further comprises a traffic data rate corresponding to the protocol data unit, and wherein determination of the sidelink relay resource is further based on the traffic data rate.

19. A non-transitory machine-readable medium, comprising executable instructions that, when executed by a processor of a source user equipment, facilitate performance of operations, comprising:
receiving, from a destination user equipment, a sidelink connection request comprising a request that the source user equipment transmit traffic to the destination user equipment;
determining a sidelink communication route between the source user equipment and the destination user equipment to result in a determined sidelink communication route, wherein the determined sidelink communication route comprises a relay user equipment as a node, a first sidelink communication link between the source user equipment and the relay user equipment, and a second sidelink communication link between the relay user equipment and the destination user equipment;
determining an end-to-end latency target corresponding to transmission of the traffic by the source user equipment and arrival of the traffic at the destination user equipment to result in a determined end-to-end latency;
based on the determined end-to-end latency, determining a sidelink configuration, wherein the sidelink configuration comprises an allowable relay link latency corresponding to the second sidelink communication link, to be used by the relay user equipment to determine a frequency range to use to transmit the traffic to the destination user equipment via the second sidelink communication link, wherein the sidelink configuration comprises a source transmission occasion indication indicative of a transmission occasion to be used by the source user equipment to transmit, by the source user equipment to the relay user equipment, the traffic, and wherein the sidelink configuration comprises at least one timing parameter value to be used by the relay user equipment to determine the frequency range to use to transmit the traffic to the destination user equipment via the second sidelink communication link;
transmitting the sidelink configuration to the relay user equipment; and
transmitting the traffic to the relay user equipment according to the transmission occasion.

20. The non-transitory machine-readable medium of claim 19, wherein the at least one timing parameter value to be used by the relay user equipment to determine the frequency range to use to transmit the traffic to the destination user equipment via the second sidelink communication link comprises at least one of: a source transmission time corresponding to transmission time of the traffic from the source user equipment to the relay user equipment, a relay transmission start time offset duration relative to the source transmission time during which the relay user equipment is to begin transmission of the traffic to the destination user equipment, a relay transmission duration during which the relay user equipment is to complete transmission of the traffic to the destination user equipment, or a data rate criterion to be used by the relay user equipment in transmitting the traffic to the destination user equipment.
